(19) United States
(12) Patent Application Publication
(10) Pub. No.: US 2006/0215212 A1
(43) Pub. Date: Sep. 28, 2006

(54) Image forming apparatus and calibration processing method and calibration processing program product for image forming apparatus

(76) Inventor: Kozo Tao, Osaka (JP)

Correspondence Address: MURAMATSU & ASSOCIATES, Suite 310, 114 Pacifica, Irvine, CA, 92618, US

(21) Appl. No.: 11/357,649

(22) Filed: Feb. 17, 2006

(30) Foreign Application Priority Data
Feb. 17, 2005 (JP) 2005-041219

(51) Int. Cl. G06K 15/00

(52) U.S. Cl. 358/1.14; 358/406; 358/1.9

(57) ABSTRACT

The present invention is to provide an image forming apparatus in which when a predetermined trigger condition occurs a calibration process is performed by user selection, and a calibration processing method and a calibration processing program product for the image forming apparatus. An image forming apparatus is provided in which a control means performs a calibration process in an image forming means under a predetermined trigger condition. When the predetermined trigger condition occurs during the execution of a print job, the control means interrupts the execution of the print job and allows an operation panel to display an error. When the performance of a calibration process is selected, the control means performs a calibration process and then re-executes the interrupted print job. Alternatively, when the continuation of the execution of the print job is selected, the control means re-executes the interrupted print job without performing a calibration process.

### BACKGROUND OF THE INVENTION

1. Field of the Invention

The present invention relates to an image forming apparatus, such as a color printing apparatus that performs color printing, and a calibration processing method and a calibration processing program for the apparatus.

2. Description of the Related Art

Conventionally, in a color printing apparatus that performs color printing, generally, in order to suppress a change in density caused by a change in development or environment, to ensure tone reproducibility, a calibration process is performed regularly or under predetermined trigger conditions.

In such a calibration process, normally, without actually performing print output on paper, color printing of a specific pattern is performed on an image bearing member, such as a photosensitive drum or an intermediate transfer member, the density value of the color printing is read by a sensor, a scanner, or the like, and a measured value that is the result of the reading is compared with a theoretical value. Based on a difference obtained by the comparison, a correction operation of process control is performed, whereby uniform output characteristics are obtained in image formation.

As described above, such a calibration process is performed regularly or under predetermined trigger conditions.

Thus, for example, in the case where a calibration process is performed for every print output of a certain number of sheets, a calibration process may be interruptingly performed during the execution of a single print job.

In the case of performing a print job of pages over the above certain number of sheets, there is no wonder in interruptingly performing a calibration process during the execution of the print job. However, in the case of performing a print job of pages less than the certain number of sheets, for example, in the case of performing a print job of several pages, if a calibration process is interruptingly performed in the course, a user who performs the print job results in facing a significantly long waiting time for the print job to be completed.

In view of this, Japanese Patent Application Laid-open (JP-A) No. 11-177822 discloses an image forming apparatus that achieves reduced waiting time for a print job that is interrupted by a calibration process.

In the image forming apparatus, an output mode of a print job to be printed is set and calibration is performed at calibration timing that matches the output mode. Thereby, in the case of a high-speed output mode, for example, by increasing the interval between calibration processes, i.e., by reducing the frequency of calibration process, the user's waiting time for calibration process can be reduced.

JP-A No. 2002-296861 discloses an image forming apparatus capable of selectively performing calibration processes of a plurality of types that correspond to different characteristics in image formation.

In the image forming apparatus, upon execution of a print job, by a user selection, only part of a calibration process is performed. During execution of the print job, only minimum necessary calibration process is performed. Thereby, the user's waiting time is reduced.

In this image forming apparatus, upon the execution of a print job only a part of a calibration process is performed by user selection. During the execution of the print job, only minimum necessary calibration process is performed. By this, the user's waiting time is reduced.

### SUMMARY OF THE INVENTION

In the above-described image forming apparatus of JP-A No. 11-177822, however, when the timing at which a calibration process is performed has come during the execution of a print job, the user cannot avoid the calibration process, and accordingly, the user faces a significantly long waiting time for the print job to complete.

In the above-described image forming apparatus of JP-A No. 2002-296851, when the timing at which a calibration process is performed has come during the execution of a print job, the user cannot avoid the minimum necessary calibration process; as a result, although the waiting time for the calibration process is relatively reduced, the waiting time for the print job to complete is increased.

The present invention is made to solve the above-described problems. An object of the present invention is to provide an image forming apparatus in which when a predetermined trigger condition occurs a calibration process is performed by user selection, and a calibration processing method and a calibration processing program product for the image-forming apparatus.

To achieve the above object, according to first aspect of the present invention, an image forming apparatus is provided comprising: image forming means for performing an image formation process; an operation panel that displays predetermined information; and control means for controlling the image forming means and the operation panel, in which the control means performs a calibration process in the image forming means under a predetermined trigger condition, wherein when the predetermined trigger condition occurs during execution of a print job, the control means interrupts the execution of the print job, allows the operation panel to display an error, and waits for a selection of either performance of a calibration process or continuation of the print job to be executed, when the performance of a calibration process is selected through the operation panel, the control means controls the image forming means to perform a calibration process and then re-executes the interrupted print job, and when the continuation of the execution of the print job is selected through the operation panel, the control means re-executes the interrupted print job without performing a calibration process.

In an image forming apparatus having such a configuration, when a predetermined trigger condition for performing a calibration process occurs, the execution (print output) of a print job is temporarily interrupted, an operation panel displays an error, and a selection by a user of either the performance of a calibration process or the continuation of the execution of the print job is made.

When the performance of a calibration process is selected through the operation panel, the image forming means is controlled to perform a calibration process and then the interrupted print job is re-executed.

Alternatively, when the continuation of the execution of the print job is selected through the operation panel, the interrupted print job is re-executed without performing a calibration process.

By this, when a predetermined trigger condition associated with a calibration process occurs during the execution of a given print job, the user can determine by his/her own free will whether or not to perform a calibration process.

Thus, for example, when the execution of a print job will be done with a few more pages or when urgent printing is performed, by the user selecting the continuation of the execution of the print job, the print job can be promptly executed without being interrupted by a calibration process and print output can be performed.

In contrast to this, when high-quality print output is desired or when print output is not urgently required, by the user selecting the performance of a calibration process, a calibration process is interruptingly performed during the execution of a print job and the print job after that can be executed with high quality.

In the image forming apparatus according to second aspect of the present invention, when the selection of either performance of a calibration process or continuation of the execution of the print job is not made through the operation panel and a predetermined period of time has elapsed, the control means may control the image forming means to perform a calibration process and then re-execute the interrupted print job without waiting for the selection to be made.

In an image forming apparatus having such a configuration, when, for example, the user is located far away from an operation panel (image forming apparatus) and thus does not make a selection of either the performance of a calibration process or the continuation of the execution of a print job, an error process for a so-called automatic continuation is performed. By doing so, the interruption time of a print job can be prevented from becoming too long.

According to third aspect of the present invention, a calibration processing method is provided for an image forming apparatus comprising: image forming means for performing an image formation process; an operation panel that displays predetermined information; and control means for controlling the image forming means and the operation panel, in which the control means performs a calibration process in the image forming means under a predetermined trigger condition, the method comprising: interrupting the execution of the print job by the control means when the predetermined trigger condition occurs during execution of a print job; allowing the operation panel to display an error by the control means and waiting for a selection of either performance of a calibration process or continuation of the print job to be executed; controlling, by the control means, when the performance of a calibration process is selected through the operation panel, the image forming means to perform a calibration process and then re-executing the interrupted print job; and re-executing, by the control means, when the continuation of the execution of the print job is selected through the operation panel, the interrupted print job without performing a calibration process.

As such, the present invention can also be realized in the form of a method.

According to fourth aspect of the present invention, a calibration processing program product for an image forming apparatus is provided that allows a computer to perform a calibration process in an image forming apparatus comprising: image forming means for performing an image formation process; an operation panel that displays predetermined information; and control means for controlling the image forming means and the operation panel, in which the control means performs a calibration process in the image forming means under a predetermined trigger condition, the product allowing the computer to perform the steps of: interrupting, by the control means, when the predetermined trigger condition occurs during execution of a print job, the execution of the print job; allowing, by the control means, the operation panel to display an error and waiting for a selection of either performance of a calibration process or continuation of the print job to be executed; controlling, by the control means, when the performance of a calibration process is selected through the operation panel, the image forming means to perform a calibration process and then re-executing the interrupted print job; or re-executing, by the control means, when the continuation of the execution of the print job is selected through the operation panel, the interrupted print job without performing a calibration process.

In this manner, the present invention can also be realized in the form of a program product.

According to the present invention, when a predetermined trigger condition occurs, by performing a calibration process by user selection, the waiting time until the completion of the execution of a print job, which is caused by the calibration process interrupting the print job, can be eliminated by user selection.

### BRIEF DESCRIPTION OF THE DRAWINGS

FIG. 1 is a block diagram showing a configuration of an image forming apparatus of the present invention.

FIG. 2 is a flowchart showing an operation of a calibration process in the image forming apparatus of FIG. 1.

FIG. 3 is a flowchart showing a specific operation of the calibration process in the image forming apparatus of FIG. 1 up to the time point where an error is displayed.

FIG. 4 is a flowchart showing a specific operation in the image forming apparatus of FIG. 1 to be performed when the performance of a calibration process is selected.

FIG. 5 is a flowchart showing a specific operation in the image forming apparatus of FIG. 1 to be performed when the continuation of the execution of a print job is selected.

### DESCRIPTION OF THE PREFERRED EMBODIMENT

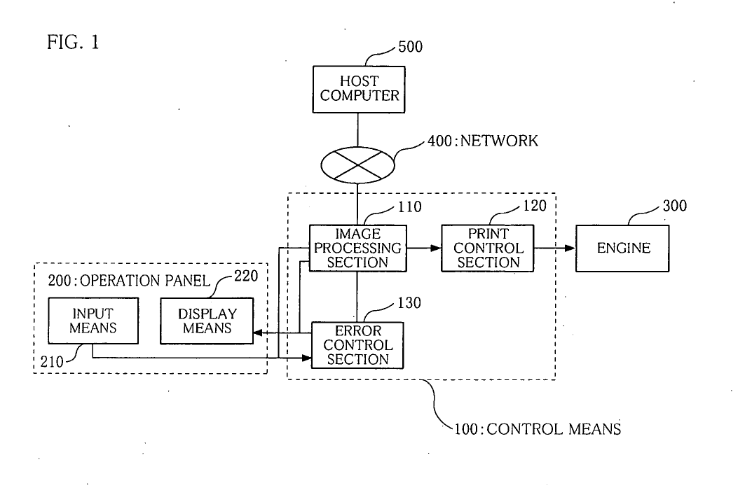

An embodiment of an image forming apparatus to which the present invention is applied will be described below with reference to FIG. 1.

FIG. 1 is a block diagram showing a configuration of an image forming apparatus of the present invention. Note that the image forming apparatus of the present embodiment includes, for example, a color printing apparatus.

As shown in FIG. 1, an image forming apparatus 10 includes a control means 100, an operation panel 200, and an image forming means (engine) 300.

In this configuration, the operation of each component of the image forming apparatus 10 is controlled by a program which operates on a computer.

The control means 100 has an image processing section 110, a print control section 120, and an error control section 130.

The image processing section 110 is interconnected with a host computer 500 through a network 400 such as LAN.

The host computer 500 is for example a personal computer. The host computer, 500 sends a data of a print job to be color print-outputted by the image forming apparatus 10, through the network 400, to the image forming apparatus 10.

The image processing section 110 interprets the data of the print job from the host computer 500 and converts the data to an intermediate language and then transmits an image on a per-page basis to the print control section 120 as a print request.

In addition, the image processing section 110 manages the print request and transmits, in order to perform a calibration process, calibration notification 111 to the error control section 130 under a predetermined trigger condition (e.g., every 80 pages of printing).

When the image processing section 110 receives an instruction to perform calibration from the error control section 130, the image processing section 110 transmits an instruction to start calibration to the print control section 120. When the image processing section 110 receives a notification of completion of the calibration from the print control section 120, the image processing section 110 resumes the execution of an interrupted print job and transmits a next print request to the print control section 120.

On the other hand, when the image processing section 110 receives an instruction to skip calibration from the error control section 130, the image processing section 110 skips a calibration process and continues the execution of an interrupted print job, and then, transmits a next print request to the print control section 120.

The print control section 120 is a driver for the engine 300, as will be described later. Using a reception of a print request made of an image on a per-page basis as a trigger from the image processing section 110, the print control section 120 issues a paper feed request to the engine 300 and sends the image based on the print request of the image.

When the print control section 120 receives an instruction to start calibration from the image processing section 110, the print control section 120 starts a calibration process to the engine 300. When the calibration process to the engine 300 is completed, the print control section 120 transmits a notification of completion of calibration to the image processing section 110.

The error control section 130 is a so-called error handler. The error control section 130 has a function of integrally managing mechanical error information, such as a paper jam, which occurs in the engine 300. Upon occurrence of an error, the error control section 130 allows the display means 220 of the operation panel 200 to display an error.

Furthermore, when the error control section 130 receives calibration notification 111 from the image processing section 110, the error control section 130 allows the display means 220 of the operation panel 200 to display an error and waits for a selection of either the performance of a calibration process or the continuation of a print job to be executed through an input means 210 of the operation panel 200. When the selection is not made for a certain period of time, the error control section 130 transmits an instruction to perform calibration to the image processing section 110.

When the performance of a calibration process is selected through the input means 210 of the operation panel 200, the error control section 130 transmits an instruction to perform calibration to the image processing section 110. When the continuation of the execution of a print job is selected through the input means 210 of the operation panel 200, the error control section 130 transmits an instruction to skip calibration to the image processing section 110.

The operation panel 200 has the input means 210 and the display means 220.

The input means 210 has an input means such as a plurality of operation keys including a so-called numeric keypad. The input means 20 allows the user to make various settings regarding print output or to perform an input operation for making the above-described selection of either the performance of a calibration process or the continuation of the execution of a print job.

The display means 220 displays a result of an input provided through the input means 210 or necessary items such as various operating statuses of the image forming apparatus 10, which include an error display brought about by the error control section 130.

The engine (image forming means) 300 sequentially performs feeding, printing, and ejecting for an image of each page, based on a paper feed request from the print control section 200.

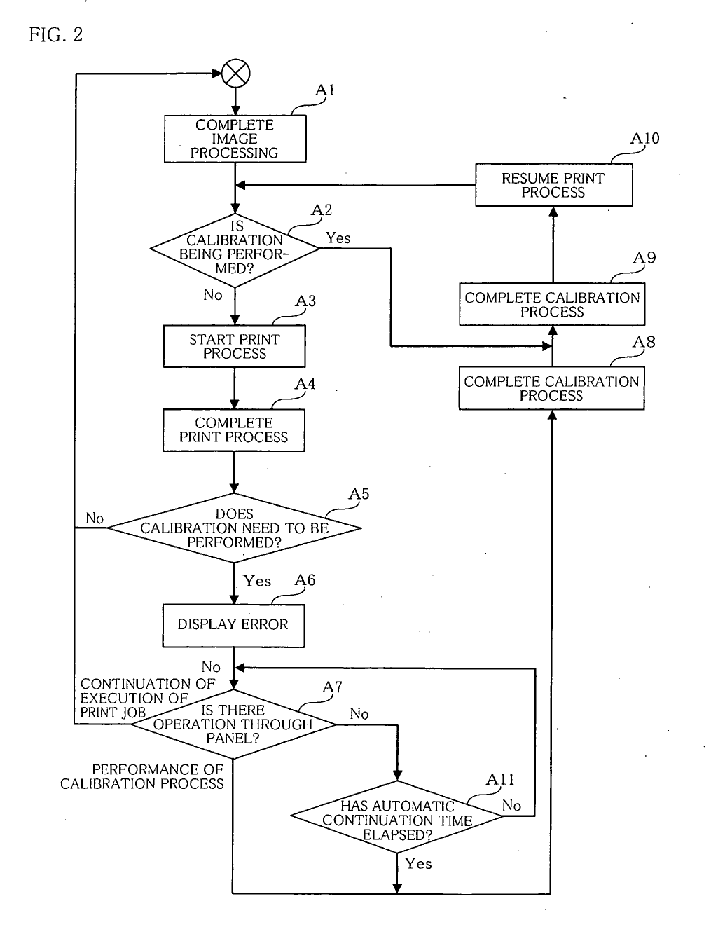

Then, the operation of a calibration process in the image forming apparatus 10 of the present embodiment will be described with reference to FIGS. 2 to 5.

FIG. 2 is a flowchart showing the operation of a calibration process.

First, at step A1, the image processing section 110 of the control means 100 completes image processing of a single page. Thereafter, a determination is made as to whether a calibration process is being performed at step A2.

If a calibration process is not being performed at step A2, the image processing section 110 starts a print process at step A3 and print output is performed in the engine 300 through the print control section 120.

Then, when the print process is completed at step A4, the image processing section 110 determines whether a predetermined trigger condition occurs, i.e., whether a calibration process needs to be performed at step A5. If a calibration process does not need to be performed, processing returns to step A1.

On the other hand, if determined that a calibration process needs to be performed at step A5, the image control means 110 transmits a calibration notification to the error control section 130. The error control section 130 allows the display means 220 of the operation panel 200 to display an error at step A6 and waits for a selection operation to be performed through the input means 210 of the operation panel 200 at step A7.

Subsequently, if the continuation of the execution of a print job is selected at step A7, processing returns to step A1. If the performance of a calibration process is selected, the image processing section 110 starts a calibration process at step A8 and the print control section 120 allows the engine 300 to perform a calibration process. When the calibration process is completed at step A9, a print process is resumed at step A10 and processing returns to step A2.

If the selection is not made through the operation panel at step A7, at step A11 after a lapse of a predetermined period of time processing proceeds to step A8 and a calibration process starts.

On the other hand, at the above-described step A2, if a calibration process is being performed, processing proceeds to step A9.

With that, the calibration process ends.

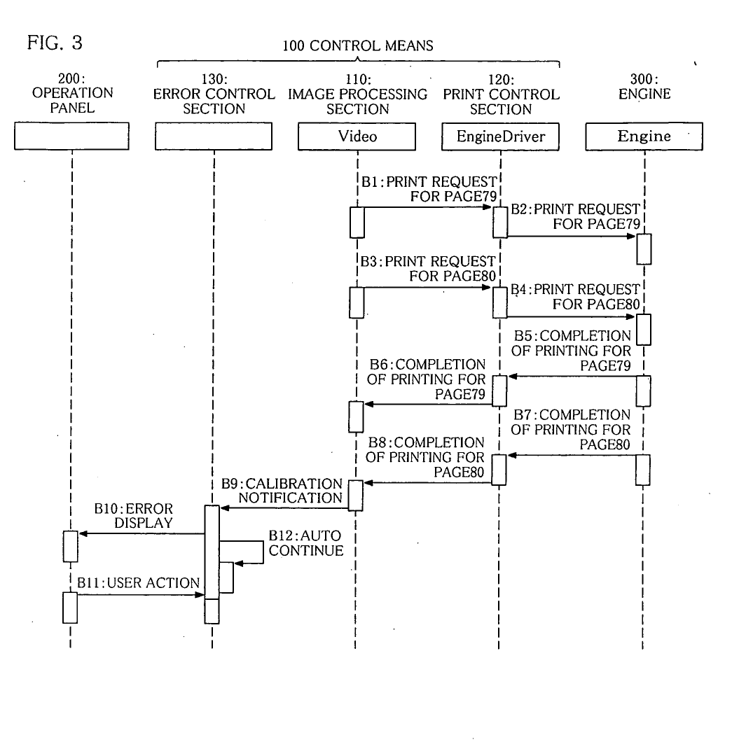

FIG. 3 is a flowchart showing a specific operation of the calibration process up to the point where an error is displayed.

In this case, a trigger condition for starting a calibration process is set to every 80 pages of printing.

First, as shown by reference numeral B1, when the image processing section 110 makes a print request for the 79th page to the print control section 120, the print control section 120 makes a paper feed request for the 79th page to the engine 300 as shown by reference numeral B2.

Subsequently, as shown by reference numeral B3, when the image processing section 110 makes a print request for the 80th page to the print control section 120, the print control section 120 makes a paper feed request for the 80th page to the engine 300 as shown by reference numeral B4.

Then, as shown by reference numeral B5, when a notification of completion of printing of the 79th page is provided to the print control section 120 from the engine 300, the print control section 120 notifies the image processing section 110 of the completion of printing of the 79th page as shown by reference numeral B6.

Subsequently, as shown by reference numeral B7, when a notification of completion of printing of the 80th page is provided to the print control section 120 from the engine 300, the print control section 120 notifies the image processing section 110 of the completion of printing of the 80th page as shown by reference numeral B8.

In this configuration, since the printing of the 80th page is completed, whereby a trigger condition for a calibration process occurs, the image processing section 110 transmits a calibration notification to the error control section 130 as shown by reference numeral B9.

In response to this, the error control section 130 allows the display means 220 of the operation panel 200 to display an error as shown by reference numeral B10. In addition, as shown by reference numeral B11, the error control section 130 waits for user selection to be made through the input means 210 of the operation panel 200.

Note that when user selection is not made for a certain period of time, the error control section 130 performs a calibration process as an automatic continuation as shown by reference numeral B12.

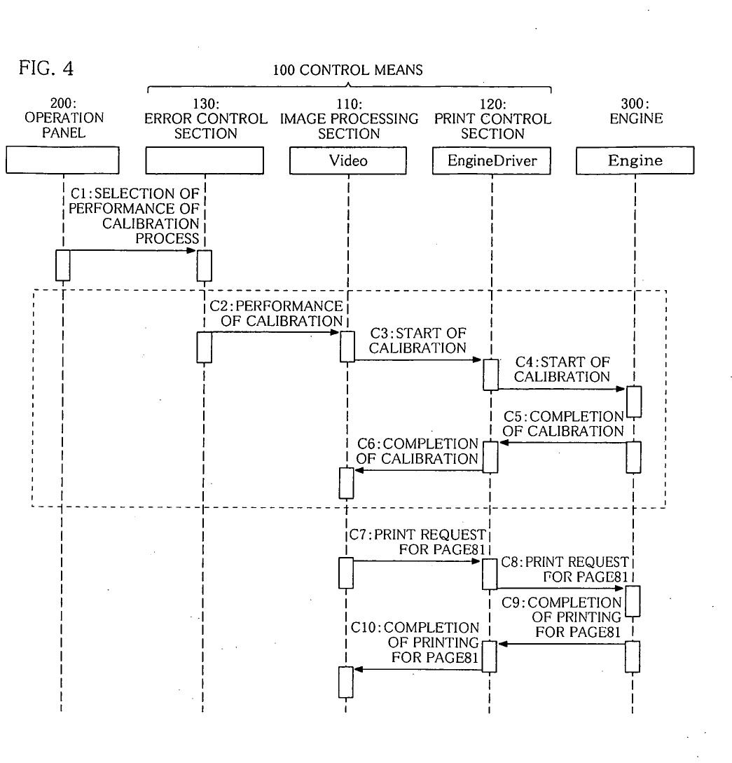

FIG. 4 is a flowchart showing an operation performed when the performance of a calibration process is selected by the user after an error is displayed as shown in FIG. 3.

First, as shown by reference numeral C1, when the user selects the performance of a calibration process using the input means 210 of the operation panel 200, the error control section 130 transmits an instruction to perform calibration to the image processing section 110 as shown by reference numeral C2.

In response to this, the image processing section 110 transmits an instruction to start calibration to the print control section 120 as shown by reference numeral C3. The print control section 120 then starts a calibration process in the engine 300 as shown by reference numeral C4.

Subsequently, as shown by reference numeral C5, when the calibration process in the engine 300 is completed, the print control section 120 transmits a notification of completion of calibration to the image processing section 110 as shown by reference numeral C6.

In response to this, the image processing section 110 starts a print process and makes a next print request, i.e., a print request for the 81st page, to the print control section 120 as shown by reference numeral C7. In response to this, the print controls section 120 makes a paper feed request for the 81st page to the engine 300 as shown by reference numeral C8.

Then, as shown by reference numeral C9, when a notification of completion of printing of the 81st page is provided to the print control section 120 from the engine 300, the print control section 120 notifies the image processing section 110 of the completion of printing of the 81st page as shown by reference numeral C10.

In this manner, the image processing section 110 sequentially makes a print request for the next page, and the print control section 120 allows the engine 300 to perform print output on the next page.

With these, the operation performed when the performance of a calibration process is selected completes.

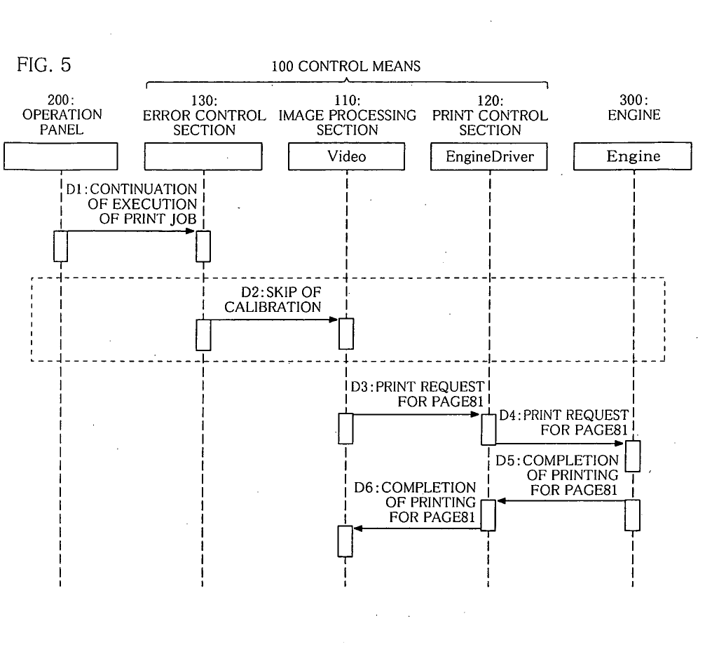

FIG. 5 is a flowchart showing an operation performed when the continuation of the execution of a print job is selected by the user after an error is displayed as shown in FIG. 3.

First, as shown by reference numeral D1, when the user selects the continuation of the execution of a print job using the input means 210 of the operation panel 200, the error control section 130 transmits an instruction to skip calibration to the image processing section 110 as shown by reference numeral D2.

In response to this, the image processing section 110 makes a next print request, i.e., a print request for the 81st page, to the print control section 120 as shown by reference numeral D3. In response to this, the print controls section 120 makes a paper feed request for the 81st page to the engine 300 as shown by reference numeral D4.

Then, as shown by reference numeral D5, when a notification of completion of printing of the 81st page is provided to the print control section 120 from the engine 300, the print control section 120 notifies the image processing section 110 of the completion of printing of the 81st page as shown by reference numeral D6.

In this manner, the image processing section 110 sequentially makes a print request for the next page, and the print control section 120 allows the engine 300 to perform print output on the next page. In this case, the performance of a print job is not interrupted by the interruption of a calibration process.

With that, the operation performed when the continuation of the execution of a print job is selected completes.

Next, a calibration processing program will be described.

A calibration processing function (the function of performing a calibration processing method) of a computer (image forming apparatus) of the above-described embodiment is implemented by a calibration processing program stored in a storage means (e.g., ROM) or a product of such a program.

The calibration processing program is read into a control means (e.g., a CPU) of the computer, thereby sending to each component of the computer an instruction to perform a predetermined process, such as a print job execution process, a print job execution interruption process, or a calibration process by the control means or an error display process by the operation panel.

By this, the calibration processing function is implemented by the calibration processing program, which is software, and the component means of the computer (image forming apparatus), which is a hardware resource, cooperating with each other.

Note that the calibration processing program for implementing the calibration processing function can be stored not only on the ROM or hard disk of the computer, but also on a computer readable storage medium such as an external storage device or a portable storage medium.

The external storage device refers to a memory expansion device that incorporates a storage medium, such as a CD-ROM, and is externally connected to a calibration processing apparatus. The portable storage medium refers to a storage medium that can be mounted on a storage medium drive device (drive device) and that can be carried about; for example, a flexible disk, a memory card, and a magnetic-optical disk.

The program stored on a storage medium is loaded into the RAM or the like of the computer and then executed by the CPU (control means). By this execution, the function of the calibration processing apparatus of the above-described embodiment is implemented.

If the user wants to load a calibration processing program using a computer, a calibration processing program stored on another computer can be downloaded-through a communication line to a RAM or an external storage device owned by the user. The downloaded calibration processing program is also executed by a CPU, whereby the calibration processing function of the calibration processing apparatus of the present embodiment is implemented.

An image forming apparatus of the present invention is described above with reference to a preferred embodiment; however, needless to say, an image forming apparatus and a calibration processing method and a calibration processing program product for the image forming apparatus, according to the present invention are not limited to those described in the above embodiment and various changes may be made within the scope of the present invention.

For example, although the above embodiment describes the case in which the image forming apparatus is a color printing apparatus, the image forming apparatus is not limited thereto; for example, it is apparent that the present invention can be applied to other types of image forming apparatuses such as a printer, a fax machine, a digital copier, and a composite device.

In this manner, according to the present invention, an image forming apparatus in which when a predetermined trigger condition occurs a calibration process is performed by user selection, and a calibration processing method and a calibration processing program product for the image forming apparatus can be provided.

The present invention can be applied to an image forming apparatus such as a printer, a fax machine, a copier, or a composite device. In particular, the present invention can be suitably applied to an image forming apparatus having a plurality of types of calibration functions.

What is claimed is:

1. An image forming apparatus comprising: image forming means for performing an image formation process; an operation panel that displays predetermined information; and control means for controlling the image forming means and the operation panel, in which the control means performs a calibration process in the image forming means under a predetermined trigger condition, wherein
when the predetermined trigger condition occurs during execution of a print job, the control means interrupts the execution of the print job, allows the operation panel to display an error, and waits for a selection of either performance of a calibration process or continuation of the print job to be executed,
when the performance of a calibration process is selected through the operation panel, the control means controls the image forming means to perform a calibration process and then re-executes the interrupted print job, and
on the other hand, when the continuation of the execution of the print job is selected through the operation panel, the control means re-executes the interrupted print job without performing a calibration process.

2. The image forming apparatus according to claim 1, wherein when the selection of either performance of a calibration process or continuation of the execution of the print job is not made through the operation panel and a predetermined period of time has elapsed, the control means controls the image forming means to perform a calibration process without waiting for the selection to be made and then re-executes the interrupted print job.

3. A calibration processing method for an image forming apparatus comprising: image forming means for performing an image formation process; an operation panel that displays predetermined information; and control means for controlling the image forming means and the operation panel, in which the control means performs a calibration process in the image forming means under a predetermined trigger condition, the method comprising:
interrupting the execution of the print job by the control means when the predetermined trigger condition occurs during execution of a print job;
allowing, by the control means, the operation panel to display an error and waiting for a selection of either performance of a calibration process or continuation of the print job to be executed;
controlling, by the control means, when the performance of a calibration process is selected through the operation panel, the image forming means to perform a calibration process and then re-executing the interrupted print job; and
re-executing, by the control means, when the continuation of the execution of the print job is selected through the operation panel, the interrupted print job without performing a calibration process.

4. A calibration processing program product for an image forming apparatus that allows a computer to perform a calibration process in an image forming apparatus comprising: image forming means for performing an image formation process; an operation panel that displays predetermined information; and control means for controlling the image forming means and the operation panel, in which the control means performs a calibration process in the image forming means under a predetermined trigger condition, the product allowing the computer to perform the steps of:
interrupting the execution of the print job by the control means when the predetermined trigger condition occurs during execution of a print job;
allowing, by the control means, the operation panel to display an error and waiting for a selection of either performance of a calibration process or continuation of the print job to be executed;
controlling, by the control means, when the performance of a calibration process is selected through the operation panel, the image forming means to perform a calibration process and then re-executing the interrupted print job; and
re-executing, by the control means, when the continuation of the execution of the print job is selected through the operation panel, the interrupted print job without performing a calibration process.
